(19) United States
(12) Patent Application Publication
(10) Pub. No.: US 2019/0380282 A1
(43) Pub. Date: Dec. 19, 2019

(54) Ground Stake Kit

(71) Applicant: Samir Burshan, Winter Garden, FL (US)

(72) Inventor: Samir Burshan, Winter Garden, FL (US)

(21) Appl. No.: 16/442,413

(22) Filed: Jun. 14, 2019

Related U.S. Application Data
(60) Provisional application No. 62/685,661, filed on Jun. 15, 2018.

(51) Int. Cl. A01G 9/12; E04H 12/22

(52) U.S. Cl. CPC A01G 9/122; E04H 12/2215

(57) ABSTRACT

A ground stake kit includes at least one elongated ground stake having a top end, a bottom end and a middle portion. The stake being constructed from a weather resistant material plastic or composite material and having a rough textured outer surface. A cap is secured to the top end of the ground stake and is constructed from a hardened material such as metal to receive repeated impacts from the striker of an air hammer. A sleeve aligns the stake with an air hammer. The sleeve includes a first end having a shape and size that is complementary to the neck of an air hammer, and a second end having an alignment collar for receiving the cap and first end of the ground stake.

### CROSS-REFERENCE TO RELATED APPLICATIONS

This application claims the benefit of U.S. Application Ser. No. 62/685,661 filed on Jun. 15, 2018, the contents of which are incorporated herein by reference.

### TECHNICAL FIELD

The present invention relates generally to farming instruments, and more particularly to a kit having one or more reusable ground stakes and a sleeve that can be utilized with existing air hammers.

### BACKGROUND

The statements in this section merely provide background information related to the present disclosure and may not constitute prior art.

Within the agricultural industry, it is common to utilize elongated stakes of various shapes and sizes to aid in stabilizing newly planted bushes and trees. Additionally, such stakes are most commonly utilized by farmers growing produce such as tomatoes, for example. Traditionally these stakes are constructed from wood and have a length between 60 and 72 inches, so as to provide support for the plant. As such, the stake is typically positioned adjacent to the plant and driven into the ground via an air hammer which strikes the top end of the stake.

Unfortunately, wood stakes are often constructed from either scrap pieces of material or from trees that are cut down in forests utilizing non-sustainable farming practices. In either instance, the wood stakes are not weather treated and must be replaced after every 1-3 seasons, thereby contributing to deforestation. Additionally, wood stakes have limited ability to absorb impacts from conventional air hammers during installation. This is especially true if the air hammer is not properly aligned with the end of the wood stake and strikes the stake at any type of angle. Indeed, this is a common problem that causes stakes to break apart, splinter, or shatter entirely, thus causing possible injuries to workers, and premature replacement of the stake itself.

With these issues in mind, and owing to increasing conservation efforts, many responsible companies are seeking alternative materials to create ground stakes that are reusable, do not deplete natural resources, are not subject to supply disruptions or market manipulations, and are not subject to the drawbacks described above.

The present invention directed to a ground stake kit differs from the conventional art in a number of aspects. The manner by which will become more apparent in the description which follows, particularly when read in conjunction with the accompanying drawings.

### SUMMARY OF THE INVENTION

The present invention is directed to a ground stake kit. One embodiment of the present invention can include a plurality of elongated ground stakes, each having a top end, a bottom end, and a middle portion. Each of the stakes can be constructed from a weather resistant material such as plastic or composites, for example, and can include a rough textured outer surface.

The kit can also include a plurality of caps that are each secured to the top end of a ground stake. The caps can be constructed from a hardened material such as metal and function to receive repeated impacts from the striker of an air hammer.

The kit can also include a sleeve having a first end that can be secured to the neck of an air hammer. The sleeve can include a second end having an alignment collar for receiving the cap and first end of a ground stake and aligning the stake linearly with the striker of the air hammer.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a ground stake kit that is useful for understanding the inventive concepts disclosed herein.

FIG. 2 is a side view of a ground stake of the ground stake kit, in accordance with one embodiment of the invention.

FIG. 3 is a perspective view of the sleeve of the ground stake kit, in accordance with one embodiment of the invention.

FIG. 4 is a perspective view of the ground stake kit in operation, in accordance with another embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

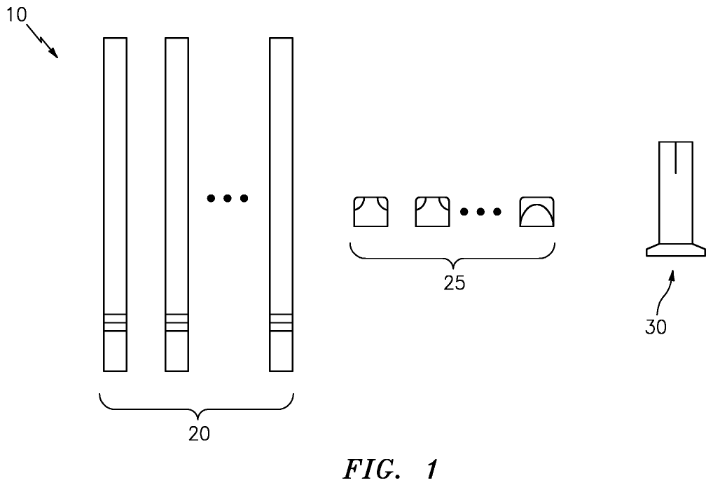

FIGS. 1-4 illustrate one embodiment of a ground stake kit 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIG. 1 illustrates one embodiment of a kit 10 that includes a plurality of ground stakes 20, stake caps 25 and a sleeve 30 adapted for use by a conventional air hammer.

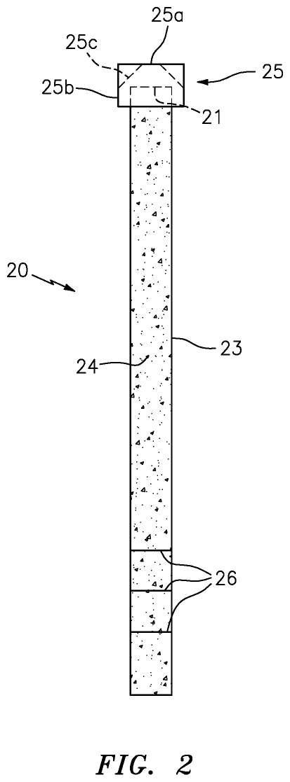

As shown in FIG. 2, one embodiment of a ground stake 20 can include an elongated generally cylindrical shaped member having a first end 21, a second end 22, and a middle portion 23. The main body can include a solid construction or can be hollow along either a portion or an entirety of the length of the stake.

In the preferred embodiment, each of the stakes 20 will be constructed from fiberglass which is flame retardant, thus allowing the farmers to burn off the string securing the stake to the plant during harvesting. Of course, the stakes are not limited to this material, as each of the stakes 20 may be formed from any number of other materials that are suitable for prolonged exposure to adverse weather conditions and that are relatively strong and stiff for their weight. Several nonlimiting examples include, but are not limited to various plastic/polymers, and/or various composite materials (e.g., carbon fibers in a polymer matrix, etc.,).

In the preferred embodiment, the exterior of the stake body will include a rough or granulated surface 24. As described herein, a “rough surface” is any surface having a high friction or gripping nature sufficient to prevent a string or other such tether that is wrapped around the stake body from slipping downward when the same is tied to a plant.

As the preferred fiberglass material for constructing the stakes is typically smooth in nature, the rough surface can be achieved via an application of abrasive materials such as fine sand that is impregnated into the winding of the fiberglass during construction of the same. Of course, other materials such as aluminum oxide or garnet, for example, are also contemplated and can be adhered to the entirety of the stake body using a wet spraying adhesive application, for example. Of course, any number of other materials, application processes or equivalents e.g., indentations and/or protrusions, for example, can be used to provide the desired rough surface.

In one embodiment, a cap 25 can be permanently or removably positioned about the top end of each stake. As shown, the cap can include a top surface 25a and a continuous side wall 25b that define a cavity into which the top end of the stake can be positioned. The cap 25 can be constructed from any number of hardened materials such as metal or metal alloys e.g., aluminum, iron, steel, titanium, or alloys thereof, for example, and can include ridging 25c or other such elements to reinforce the top surface in order to allow the cap to be repeatedly struck by an air hammer without damage.

The inclusion of a reinforced cap 25 that is constructed from a hardened material allows the cap to absorb the descriptive impact forces of an air hammer while transferring the downward pressure to the stake. Such a feature advantageously preventing damage to the stake so as to allow the same to be reused again and again.

In the preferred embodiment, a plurality of markings 26 can be provided along the main body to aid a user in hammering the stake to a desired depth. In the preferred embodiment, the markings 26 can include, comprise or consist of three distinct lines which can be painted, printed or otherwise provided in any number of different colors. The three lines can preferably be positioned at twelve, eighteen and twenty-four inches from the bottom end 22 of the stake. Such dimensions being particularly chosen for use with produce plants such as tomatoes, for example; however other stakes may be constructed having depth markers at different locations for use with different plants.

22 and can have a vertical separation distance from each other of six inches (e.g., the lines will preferably

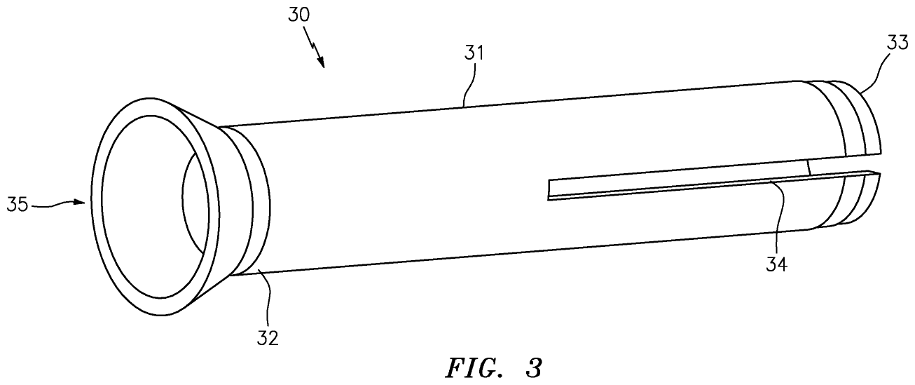

FIG. 3 illustrates one embodiment of a sleeve 30 that can function to allow a user to quickly and easily align the striking portion of an air hammer with the cap 25 of a stake 20 so as to ensure each strike is in a purely linear/downward motion. As shown, the sleeve 30 can include an elongated hollow cylindrical body 31 having a first end 32, a second end 33, and an elongated slit 34 that extends from the second end 33 toward the middle portion of the cylindrical body.

As described herein, the sleeve 30 may be formed from materials that are, for example, relatively strong and stiff for their weight. Several nonlimiting examples include but are not limited to various metals or metal alloys (e.g., aluminum, steel, titanium, or alloys thereof), plastic/polymers (e.g., high-density polyethylene (HDPE), rigid polyvinyl chloride (PVC), or polyethylene terephthalate (PET)), and/or various composite materials (e.g., carbon fibers in a polymer matrix, fiberglass, etc.).

In the preferred embodiment, the cylindrical body will include an inside diameter that is complementary to the outside diameter of the cap 25, so as to allow the cap to be positioned within the cylindrical body for engagement by the air hammer. Additionally, the first end can include an alignment collar portion 35 extending outward, so as to allow a user to guide the sleeve onto a stake, as will be described below.

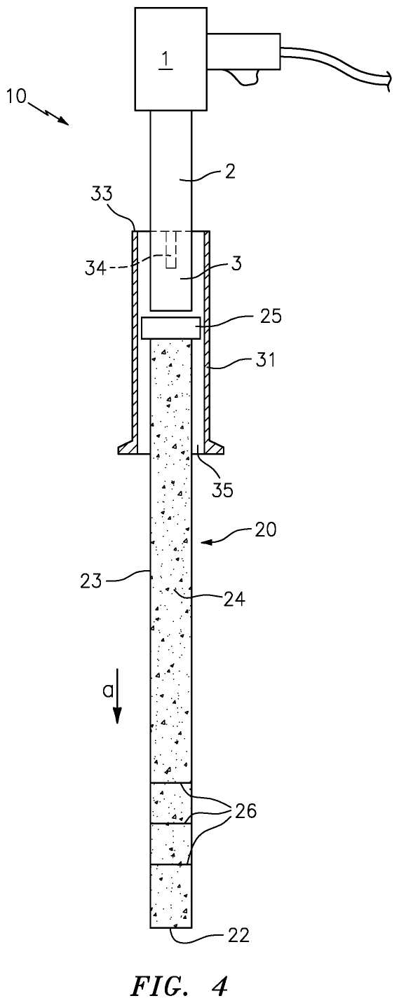

FIG. 4 illustrates one embodiment of the kit 10 in operation with an air hammer 1. As shown, the second end of the sleeve 33 can be secured along neck 2 of the air hammer. In this regard, the slit functions to allow the diameter of the second end to expand and contract, so as to accommodate differences in shapes and sizes of air hammer necks.

Next, the user can position the top end of the stake and cap 25 through the alignment collar 35 until the cap is located within the cylindrical main body section 31 and is in contact with the striking portion 3 of the air hammer 1. When so positioned, the striking portion will be aligned directly above the top center of the cap, and the hammer can be engaged causing the striker to repeatedly impact the cap. Because the striker is aligned linearly with the cap, the linear movement of the striker will engage the top surface of the cap in the middle, so as to drive the cap and stake downward in a purely linear manner (see arrow a) to any desired depth.

Accordingly, the inventive concepts function to ensure the air hammer is properly aligned with the cap each and every time, thereby ensuring the stake is not damaged, and allowing a single stake to be reused an indefinite number of times.

As described herein, one or more elements of the kit 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A kit, comprising:
at least one elongated stake having a top end, a bottom end and a middle portion;
at least one cap that is positioned along the top end of the at least one elongated stake; and
a sleeve that is configured to engage an air hammer and to align a striker of the air hammer with the at least one cap.

2. The kit of claim 1, wherein the sleeve comprises:
an elongated cylindrical member having an inside diameter that is complementary to an outside diameter of the at least one cap;
a first end having an alignment collar extending outward therefrom; and
an open second end having a shape and size that is complementary to a shape and a size of a neck portion of the air hammer.

3. The kit of claim 2, wherein the sleeve further comprises:
an elongated slit that extends from the open second toward a middle portion of the cylindrical member, said slit functioning to allow the shape and size of the open second end to change.

4. The kit of claim 1, wherein each of the at least one elongated stake is constructed from plastic that is suitable for prolonged exposure to adverse weather conditions.

5. The kit of claim 1, wherein each of the at least one elongated stake is constructed from composite materials that are suitable for prolonged exposure to adverse weather conditions.

6. The kit of claim 1, wherein each of the at least one cap includes a flat top surface and a continuous sidewall defining a cavity for receiving the top end of the at least one stake.

7. The kit of claim 6, wherein each of the at least one cap is constructed from a hardened material that is configured to be engaged by the striker of the air hammer.

8. The kit of claim 7, wherein each of the at least one cap is constructed from metal.
